(19) United States
(12) Patent Application Publication
(10) Pub. No.: US 2018/0011192 A1
(43) Pub. Date: Jan. 11, 2018

(54) FORWARD/SIDE SCANNING SONAR DEVICE, SYSTEM AND METHOD

(71) Applicant: Western Marine Electronics Company, Woodinville, WA (US)

(72) Inventor: Bruce H. Blakey, Woodinville, WA (US)

(21) Appl. No.: 15/203,066

(22) Filed: Jul. 6, 2016

(51) Int. Cl. G01S 15/89; G10K 11/16; G01S 15/96

(52) U.S. Cl. CPC G01S 15/8902; G01S 15/96; G10K 11/16

(57) ABSTRACT

A sonar system includes a sonar transducer having a plurality of transducer elements and a transceiver. The transceiver generates transducer drive signals and receives transducer echo signals. The system includes control circuitry, which, in operation, selectively couples transducer elements of the plurality of transducer elements to the transceiver. In a side scan mode of operation, the plurality of transducer elements are coupled to the transceiver, and in a forward scan mode of operation a subset of the plurality of transducer elements is coupled to the transceiver.

### BACKGROUND

### Technical Field

The present disclosure relates to sound navigation and ranging (sonar) and related systems, methods and articles.

### Description of the Related-Art

Active sonar uses reflected sound waves both to navigate and to detect objects, such as fish. Typically, the sound transmission media is water.

In commercial fishing, wide-beam forward scanning sonar (searchlight scanning) is typically used to provide a view of the ocean floor in front of the vessel for navigation purposes. However, narrow-beam side scanning sonar is typically used to locate objects, such as fish, around the vessel.

### BRIEF SUMMARY

In an embodiment, a device comprises: a sonar transducer having a plurality of transducer elements; a transceiver, which, in operation, generates transducer drive signals and receives transducer echo signals; and control circuitry, which, in operation, selectively couples transducer elements of the plurality of transducer elements to the transceiver, wherein in a first mode of operation the control circuitry couples a first set of the plurality of transducer elements to the transceiver and in a second mode of operation the control circuitry couples a second set of the plurality of transducer elements to the transceiver. In an embodiment, the first mode of operation is a forward scan mode of operation and the first set of the plurality of transducer elements is a single transducer element. In an embodiment, the second mode of operation is a side scan mode of operation and the second set of the plurality of transducer elements comprises all of the transducer elements of the plurality of transducer elements. In an embodiment, the single transducer element is a ceramic crystal. In an embodiment, the plurality of transducer elements includes the ceramic crystal and an array of transducer elements. In an embodiment, the plurality of transducer elements are arranged in an array having a first region of transducer elements and one or more second regions of transducer elements. In an embodiment, the first mode of operation is a forward scan mode of operation and the first set of the plurality of transducer elements is the transducer elements of the first region of the array of transducer elements. In an embodiment, the first region is a center region of the array. In an embodiment, the second mode of operation is a side scan mode of operation and the second set of the plurality of transducer elements comprises all of the transducer elements of the array. In an embodiment, the plurality of transducer elements comprises a single transducer positioned in a first region of the transducer and an array of transducer elements positioned in a second region of the transducer; the first mode of operation is a forward scan mode of operation and the first set of the plurality of transducer elements is the single transducer element in the first region of the transducer; and the second mode of operation is a side scan mode of operation and the second set of transducer elements is the array of transducer elements positioned in the second region of the transducer.

In an embodiment, a system comprises: a device according to any of the disclosed embodiment; and a sound dome, wherein the sonar transducer is positioned in the sound dome. In an embodiment, the system comprises a sound dome stabilizer control system in the sound dome. In an embodiment, the sound dome stabilizer control system, in operation, translates in three axes in unison with the sonar transducer and rotates on all three axes in unison with the sonar transducer.

In an embodiment, a method comprises: coupling a plurality of transducer elements of a sonar transducer to a transceiver in a first mode of operation; and coupling a subset of the plurality of transducer elements of the sonar transducer to the transceiver in a second mode of operation. In an embodiment, the second mode of operation is a forward scan mode of operation and the subset of the plurality of transducer elements is a single transducer element. In an embodiment, the first mode of operation is a side scan mode of operation. In an embodiment, the single transducer element is a ceramic crystal. In an embodiment, the plurality of transducer elements includes the ceramic crystal and an array of transducer elements. In an embodiment, the plurality of transducer elements are arranged in an array having a first region of transducer elements and one or more second regions of transducer elements. In an embodiment, the second mode of operation is a forward scan mode of operation and the subset of the plurality of transducer elements is the transducer elements of the first region of the array of transducer elements. In an embodiment, the first region is a center region of the array. In an embodiment, the first mode of operation is a side scan mode of operation. In an embodiment, the method comprises time multiplexing the first mode of operation and the second mode of operation.

In an embodiment, a device comprises circuitry, which, in operation, performs any of the methods disclosed herein. In an embodiment, a system comprises a device as disclosed herein.

In an embodiment, a method comprises: coupling a first set of transducer elements of a plurality of transducer elements of a sonar transducer to a transceiver in a first mode of operation; and coupling a second set of transducer elements of the plurality of transducer elements of the sonar transducer to the transceiver in a second mode of operation. In an embodiment, the second mode of operation is a forward scan mode of operation and the second set of the plurality of transducer elements is a single transducer element. In an embodiment, the first mode of operation is a side scan mode of operation. In an embodiment, the first set of transducer elements is an array of transducer elements. In an embodiment, the single transducer element is a ceramic crystal. In an embodiment, the plurality of transducer elements are arranged in an array having a first region of transducer elements and one or more second regions of transducer elements. In an embodiment, the first mode of operation is a forward scan mode of operation and the first set of transducer elements are in the first region of transducer elements; and the second mode of is a side scan mode of operation and the second set of transducer elements includes transducer elements of the first and second regions of transducer elements.

### BRIEF DESCRIPTION OF THE SEVERAL VIEWS OF THE DRAWING(S)

FIG. 1 shows a functional block diagram of an embodiment of a combination forward and side scan sonar system.

FIGS. 2 and 3 show perspective views of an embodiment of a dual beam/dual frequency transducer.

FIGS. 4 and 5 show perspective views of an embodiment of a dual beam/dual frequency transducer.

FIG. 6 is a functional block diagram of an embodiment of a sonar control and driver system.

FIG. 7 illustrates an embodiment of a method of controlling a combination forward and side scan sonar system.

### DETAILED DESCRIPTION

In the following description, certain details are set forth in order to provide a thorough understanding of various embodiments of devices, systems, methods and articles. However, one of skill in the art will understand that other embodiments may be practiced without these details. In other instances, well-known structures and methods associated with, for example, receivers, processors, switches, sonars, etc., have not been shown or described in detail in some figures to avoid unnecessarily obscuring descriptions of the embodiments.

Unless the context requires otherwise, throughout the specification and claims which follow, the word “comprise” and variations thereof, such as “comprising,” and “comprises,” are to be construed in an open, inclusive sense, that is, as “including, but not limited to.”

Reference throughout this specification to “one embodiment,” or “an embodiment” means that a particular feature, structure or characteristic described in connection with the embodiment is included in at least one embodiment. Thus, the appearances of the phrases “in one embodiment,” or “in an embodiment” in various places throughout this specification are not necessarily referring to the same embodiment, or to all embodiments. Furthermore, the particular features, structures, or characteristics may be combined in any suitable manner in one or more embodiments to obtain further embodiments.

The headings are provided for convenience only, and do not interpret the scope or meaning of this disclosure or the claimed invention.

The sizes and relative positions of elements in the drawings are not necessarily drawn to scale. For example, the shapes of various elements and angles are necessarily not drawn to scale, and some of these elements are enlarged and positioned to improve drawing legibility. Further, the particular shapes of the elements as drawn are not necessarily intended to convey any information regarding the actual shape of particular elements, and have been selected solely for ease of recognition in the drawings. In addition, the use of geometric terms and the illustrations are not intended to indicate that embodiments have ideal geometric shapes.

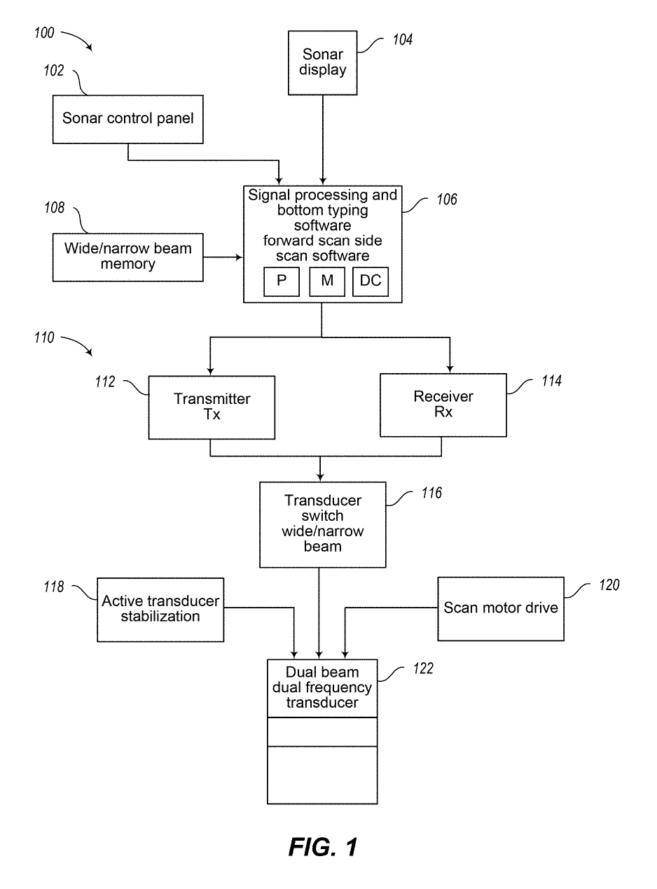

FIG. 1 shows a functional block of an embodiment of combination forward scan and side scan sonar system 100. As illustrated, the system 100 comprises a control panel or console 102, a sonar display 104, a signal processing system 106, a beam memory 108, a transceiver 110, a transducer switch 116, an active transducer stabilization system 118, a scan motor drive 120 and a dual beam, dual frequency transducer 122.

The sonar control panel 102 is coupled to the signal processing system 106, and, in operation, receives input to control operation of the system 100 and transmits control signals based on the input to the signal processing system 106. The control panel may comprise one or more user interfaces, switches, etc., which may be used to select one or more operational modes of the system (e.g., a forward scan only mode, a side scan only mode, a combination mode (e.g., time multiplexed), etc.), one or more scanning routines, one or more display modes, one or more scanning parameters, etc., and various combinations thereof.

The sonar display 104 is coupled to the signal processing system 106, and, in operation, displays images generated by the system 100, such as images of the navigation channel, images showing the location of fish, etc. In some embodiments, the control panel 102 and the display 104 may be integrated into a single control interface/display. In some embodiments, multiple displays, split screen displays, or screens within a screen may be employed.

The signal processing system 106 as illustrated comprises a processor P, a memory M and discrete circuitry DC. In some embodiments, the signal processing system 106 may comprise state machines, switches, look-up tables, etc., in addition to, or instead of, the illustrated processor P and/or the memory M. The components of the signal processing system 106 may be used alone or in various combinations to implement the functionality of the system 100. The signal processing system 106 may be configured to control operation of the system 100, for example based on signals received from the sonar control panel 102, stored scanning sequences, stored sonar image generating and processing routines (e.g., routines to control the system 100 to generate sonar scan signals, and to process echo signals to generate sonar images), states of a state machine, etc., and various combinations thereof.

The beam memory 108 stores data related to the scan and echo signals, which may be used to control scanning and image processing by the system 100. The beam memory may also store programs to implement the functionality of the system 100. In some embodiments, the beam memory may be integrated into the signal processing system 106, may comprise multiple memories, etc., and various combinations thereof.

The transceiver 110 comprises a transmitter 112 and a receiver 114, and in operation transmits transducer drive signals to the transducer 122 (via the transducer switch 116) based on control signals received from the signal processing system 106, and transmits echo signals received from the transducer to the signal processing system 106.

The transducer switch 116 selectively couples transducer drive signals generated by the transceiver 110 to transmission elements of the transducer 122 based on control signals received from the signal processing circuitry 106, as discussed in more detail below.

The transducer 122 comprises multiple individual transducer elements, for example a 160 kHz ceramic crystal and a 500 kHz composite array, an array of transducer elements having distinct array portions, etc., which, in operation, are selectively coupled to the transceiver 110 in response to control signals generated by the signal processing control system 106. For example, in a forward scan mode of operation, the transceiver 110 may be coupled to a 160 kHz ceramic crystal of an embodiment of the transducer 122 and wide beam scanning may be employed. In a side scan mode of operation, the transceiver 110 may be coupled to both a 160 kHz ceramic crystal of an embodiment of the transducer 122 and a 500 kHz composite transducer array of the embodiment of the transducer 122, and narrow beam scanning may be employed.

The active transducer stabilization system 118, in operation, stabilizes the transducer to facilitate control of the scanning beams. In an embodiment, the active transducer stabilization system may comprise an electronic gyroscope mounted on the transducer 122, or otherwise configured to move in unison with the transducer with respect to axes of movement and rotation (e.g., rigidly coupled to, embedded in, etc.), to generate signals to compensate for pitch and roll when the beam is scanning. In an embodiment, the transducer 122 and the active transducer stabilization system 118 are positioned in a sound dome of a fishing vessel.

The scan motor drive 129, in operation, controls movement of transducer 122 during scanning operations, in response to control signals received from the signal processing system 106 and/or the active transducer stabilization system 118.

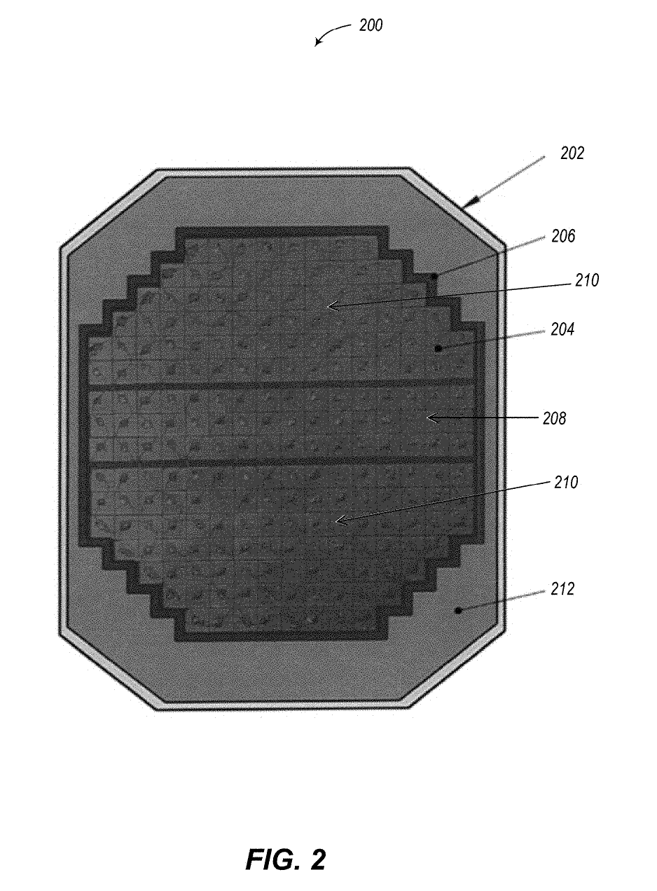

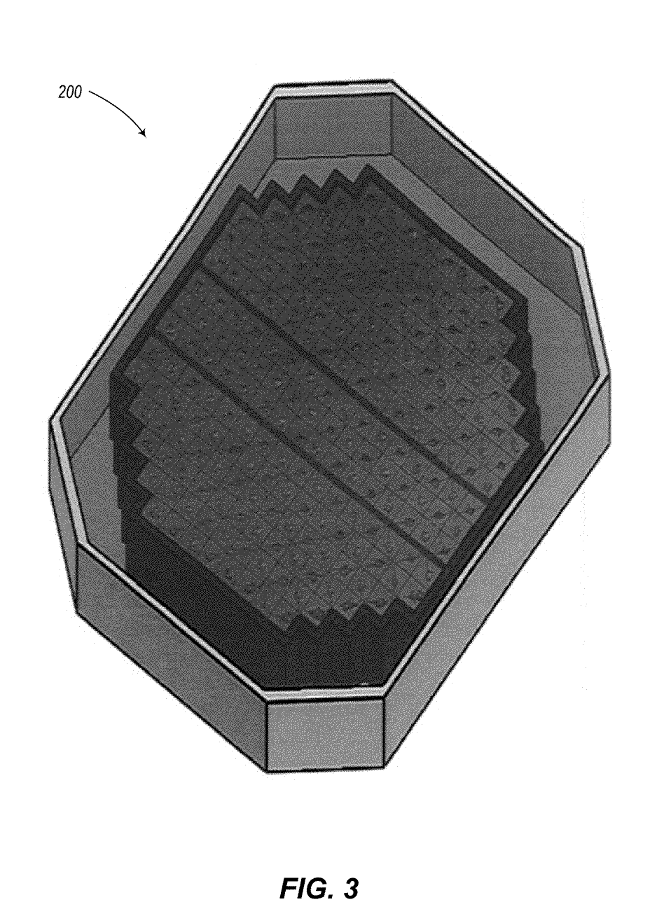

FIGS. 2 and 3 show perspective views of an embodiment of a dual beam/dual frequency transducer 200. The transducer 200 has an outer housing, as illustrated a machined cup 202, a plurality of transducer elements 204 surrounded by barrier 206. The transducer elements 204 comprise a center portion 208 of transducer elements and outer portions of transducer elements 210. As illustrated, 216 transducer elements 204 are configured as an array having a center portion 208 and two outer portions 210. The transducer elements of the array may comprises a plurality of individual ceramic crystal transducer elements. In a forward scan mode of operation, for example, the transducer elements of the center portion 208 of the transducer 200 may be coupled to a transceiver (see transceiver 110 of FIG. 1) to scan using a wide beam. In a side scan mode of operation, for example, the transducer elements of the center portion 208 and of the outer portions 210 may be coupled to the transceiver to scan using a narrow beam. The barrier 206 may comprise, for example, epichlorhydrin foam of, for example, 1/16 of an inch thickness. As illustrated, the barrier 206 is surrounded by epoxy 212.

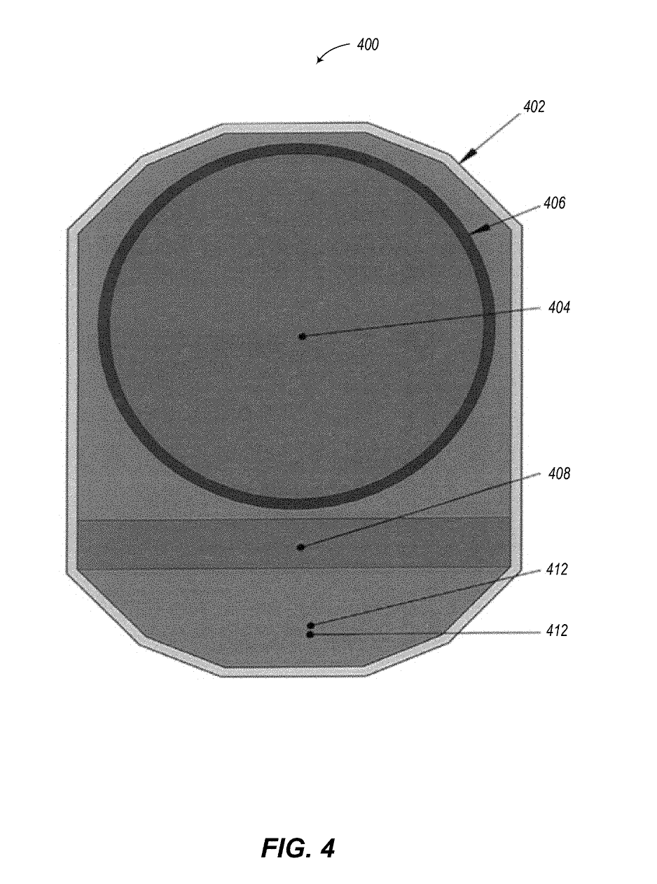

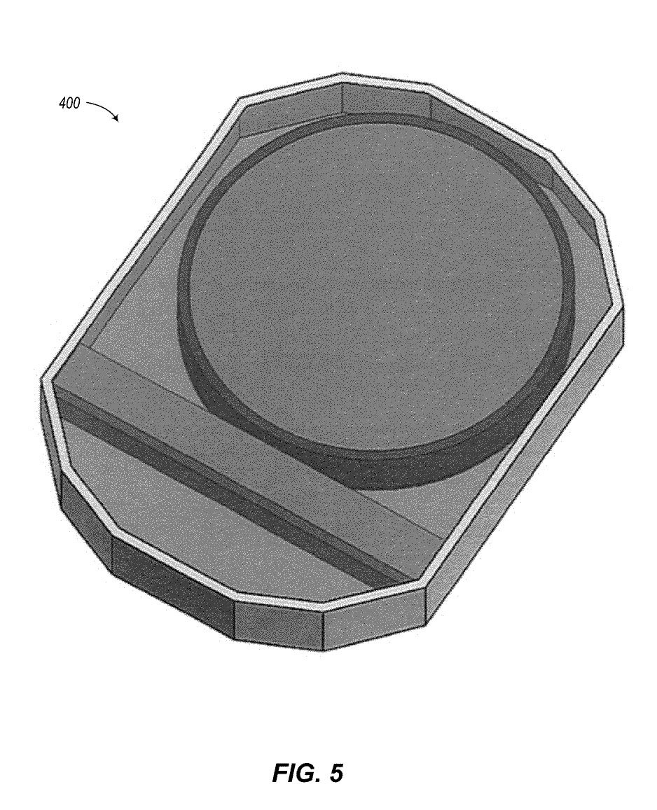

FIGS. 4 and 5 show perspective views of another embodiment of a dual beam/dual frequency transducer 400. The transducer 400 has an outer housing, as illustrated a machined crystal cup 402, a ceramic crystal 404 is positioned in the center of a region inside a barrier 406. The ceramic crystal may comprise, for example, a 160 kHz ceramic crystal. The transducer also has a plurality of transducer elements 408, which as illustrated are configured in an array. The transducer elements 408 of the array may comprises a plurality of individual ceramic crystal transducer elements, which may be a same type as the ceramic crystal 404. In a forward scan mode of operation, for example, the ceramic crystal 404 of the transducer 400 may be coupled to a transceiver (see transceiver 110 of FIG. 1) to scan using a wide beam. In a side scan mode of operation, for example, the plurality of transducer elements 408 may be coupled to the transceiver to scan using a narrow beam. The barrier 406 may comprise, for example epichlorhydrin foam of, for example, 1/16 of an inch thichness. As illustrated, the barrier 406 and the plurality of transducer elements 408 are surrounded by epoxy 412. Optionally, a barrier may be positioned between the plurality of transducer elements 408 and the epoxy 412.

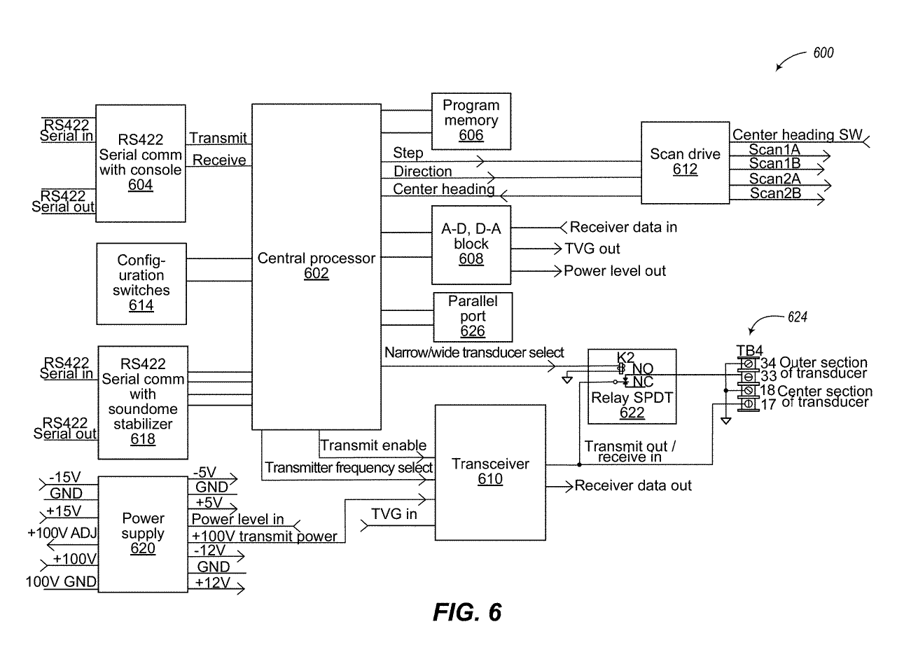

FIG. 6 is a functional block diagram of an embodiment of a sonar control and driver system 600. As illustrated, the system 600 comprises a central processor 602, a console interface 604, a program memory 606, an analog to digital and digital to analog converter 608, a transceiver 610, scan driving circuitry 612, configuration switches 614, a sound dome stabilizer interface 618, a power supply 620, a relay switch 622, a transducer interface block 624 and a parallel interface 626.

The central processor 602, in operation, generates control signals to control operation of a sonar system, such as the sonar system 100 of FIG. 1. The central processor 602, in operation, communicates with a control console through the console interface 604. The program memory 606 stores programs which may be executed by the central processor 602 to implement one of more functions of the control and driver system 600. The analog to digital and digital to analog converter 608, in operation, converts analog signals from the transceiver 610 to digital signals provided to the central processor 602 and converts digital control signals from the central processor to analog signals provided to the power supply 620 and to the transceiver 610. The transceiver 610, in operation, generates transducer driver signals and receives transducer echo signals. The scan driving circuitry 612, in operation, receives control signals from the central processor 602 and generates signals to drive a scan motor based on the control signals. The configuration switches 614 store configuration information which, in operation, is used by the system 600. The central processor 602, in operation, communicates with an active transducer stabilization system through the sound dome stabilizer interface 618. The power supply 620, in operation, converts received power into power used by the various components of the system 600.

The relay switch 622, in operation, responds to control signals from the central processor 602 by selective coupling one or more transducer elements of the transducer to the transceiver 610 through the transducer interface block 624.

The parallel port or interface 626 may be coupled, for example, to a display (see display 104 of FIG. 1). The system 600 may include other circuitry, such as a display driver, other interfaces, such as another or different display interface, etc.

In some embodiments, the central processor 602 may comprise state machines, discrete circuitry, look-up tables, etc., in addition to, or instead of, the illustrated central processor 602.

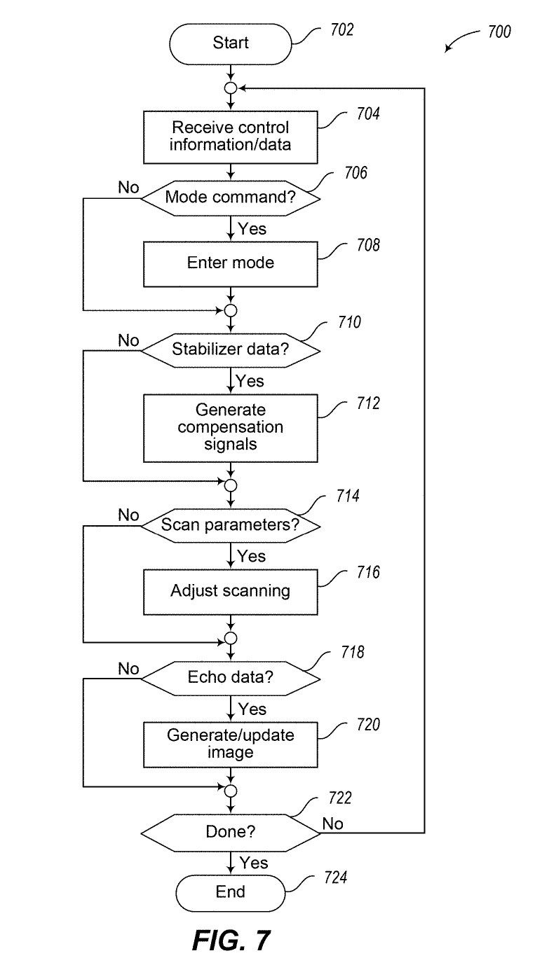

FIG. 7 illustrates an embodiment of a method or subroutine 700 of controlling a combination forward and side scan sonar system. For ease of illustration, FIG. 7 will be described in the context of the sonar system 100 of FIG. 1 and the sonar control and driver system 600 of FIG. 6. Other sonar systems and control and driver systems may be employed.

The method 700 starts at 702 and proceeds to 704. At 704, the system receives control information or data, such as control information from the console or control panel 102 received via the interface 604, data from the sound dome stabilizer 118 via the interface 618, receiver data from transceiver 610 via converter 608, etc. The method 700 proceeds from 704 to 706.

At 706, the system 600 determines whether the received control information or data is a mode command. When it is determined that the received control information or data is a mode command, the method 700 proceeds from 706 to 708, where the system 600 generates control signals to cause the system to enter the selected mode (e.g., control signals to cause the switch 622 to close to couple the outer sections of the transducer elements to the transceiver when a side scan mode of operation is selected; control signals to cause the switch 622 to open to uncouple the outer sections of transducer elements from the transceiver when a forward scan mode of operation is selected; control signals to time multiplex side scan and forward scan modes when a combination mode of operation is selected; etc.). The method proceeds from 708 to 710. When it is not determined at 706 that the received control information or data is a mode command, the method 700 proceeds from 706 to 710.

At 710, the system 600 determines whether the received control information or data is stabilizer data. When it is determined that the received control information or data is stabilizer data, the method 700 proceeds from 710 to 712, where the system 600 selectively generates or modifies control signals in response to the stabilizer data (e.g., to adjust scan drive signals to compensate for pitch or roll indicated by the stabilizer data, etc.). The method proceeds from 712 to 714. When it is not determined at 710 that the received control information or data is stabilizer data, the method 700 proceeds from 710 to 714.

At 714, the system 600 determines whether the received control information or data comprises scan parameters, such as configuration information stored in the configuration switches, parameters entered via the console, parameters from a selected scanning program or subroutine, etc. When it is determined that the received control information or data comprises scan parameters, the method 700 proceeds from 714 to 716, where the system 600 selectively generates or modifies control signals in a manner consistent with the scanning parameters (e.g., scan drive signals, frequency signals, voltage level signals, etc.). The method proceeds from 716 to 718. When it is not determined at 714 that the received control information or data comprises scanning parameters, the method 700 proceeds from 714 to 718.

At 718, the system 600 determines whether the received control information or data comprises echo data, received, for example, from the transducer via the transceiver. When it is determined that the received control information or data comprises echo data, the method 700 proceeds from 718 to 720, where the system 600 generates or updates signals to display one or more sonar images based on the received echo data (e.g., signals to update a side scan image when the echo data is side scan data; signals to update a forward scan image when the echo data is forward scan data; etc.). It is noted that some embodiments may display side scan and forward scan images in a split screen, may display side scan and forward scan images on separate displays, may store scan images, etc. The method proceeds from 720 to 722. When it is not determined at 718 that the received control information or data comprises echo data, the method 700 proceeds from 718 to 722.

At 722, the system 600 determines whether to continue processing received control information or data. When it is determined to continue processing received control information or data, the method proceeds from 722 to 704. When it is not determined at 722 to continue processing control information or data, the method 700 proceeds from 722 to 724, where the method terminates, enters a sleep mode, etc.

Embodiments of the method 700 may contain other acts, may not contain all of the illustrated acts, and may perform acts in various orders. For example, while FIG. 7 illustrates acts as sequential, in some embodiments, acts may be performed in parallel or in different orders. In another example, in some embodiments at 720 scanning parameters may be adjusted in response to the echo data in addition to or instead of updating image data.

Some embodiments may take the form of or comprise computer program products. For example, according to one embodiment there is provided a computer readable medium comprising a computer program adapted to perform one or more of the methods or functions described above. The medium may be a physical storage medium such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the methods and/or functionality may be implemented or provided in other manners, such as at least partially in firmware and/or hardware, including, but not limited to, one or more application-specific integrated circuits (ASICs), digital signal processors, discrete circuitry, logic gates, state machines, standard integrated circuits, controllers (e.g., by executing appropriate instructions, and including microcontrollers and/or embedded controllers), field-programmable gate arrays (FPGAs), complex programmable logic devices (CPLDs), etc., as well as devices that employ RFID technology, and various combinations thereof.

The various embodiments described above may be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device, comprising:
a sonar transducer having a plurality of transducer elements;
a transceiver, which, in operation, generates transducer drive signals and receives transducer echo signals; and
control circuitry, which, in operation, selectively couples transducer elements of the plurality of transducer elements to the transceiver, wherein in a first mode of operation the control circuitry couples a first set of the plurality of transducer elements to the transceiver and in a second mode of operation the control circuitry couples a second set of the plurality of transducer elements to the transceiver.

2. The device of claim 1 wherein the first mode of operation is a forward scan mode of operation and the first set of the plurality of transducer elements is a single transducer element.

3. The device of claim 2 wherein the second mode of operation is a side scan mode of operation and the second set of the plurality of transducer elements comprises all of the transducer elements of the plurality of transducer elements.

4. The device of claim 2 wherein the single transducer element is a ceramic crystal.

5. The device of claim 4 wherein the plurality of transducer elements includes the ceramic crystal and an array of transducer elements.

6. The device of claim 1 wherein the plurality of transducer elements are arranged in an array having a first region of transducer elements and one or more second regions of transducer elements.

7. The device of claim 6 wherein the first mode of operation is a forward scan mode of operation and the first set of the plurality of transducer elements is the transducer elements of the first region of the array of transducer elements.

8. The device of claim 7 wherein the first region is a center region of the array.

9. The device of claim 8 wherein the second mode of operation is a side scan mode of operation and the second set of the plurality of transducer elements comprises all of the transducer elements of the array.

10. The device of claim 1 wherein,
the plurality of transducer elements comprises a single transducer positioned in a first region of the transducer and an array of transducer elements positioned in a second region of the transducer;
the first mode of operation is a forward scan mode of operation and the first set of the plurality of transducer elements is the single transducer element in the first region of the transducer; and
the second mode of operation is a side scan mode of operation and the second set of transducer elements is the array of transducer elements positioned in the second region of the transducer.

11. The device of claim 1, comprising:
a sound dome, wherein the sonar transducer is positioned in the sound dome.

12. The device of claim 11, comprising a sound dome stabilizer control system in the sound dome.

13. The device of claim 12 wherein the sound dome stabilizer control system, in operation, translates in three axes in unison with the sonar transducer and rotates on all three axes in unison with the sonar transducer.

14. A method, comprising:
coupling a first set of transducer elements of a plurality of transducer elements of a sonar transducer to a transceiver in a first mode of operation; and
coupling a second set of transducer elements of the plurality of transducer elements of the sonar transducer to the transceiver in a second mode of operation.

15. The method of claim 14 wherein the second mode of operation is a forward scan mode of operation and the second set of the plurality of transducer elements is a single transducer element.

16. The method of claim 15 wherein the first mode of operation is a side scan mode of operation.

17. The method of claim 16 wherein the first set of transducer elements is an array of transducer elements.

18. The method of claim 15 wherein the single transducer element is a ceramic crystal.

19. The method of claim 13 wherein the plurality of transducer elements are arranged in an array having a first region of transducer elements and one or more second regions of transducer elements.

20. The method of claim 19 wherein,
the first mode of operation is a forward scan mode of operation and the first set of transducer elements are in the first region of transducer elements; and
the second mode of is a side scan mode of operation and the second set of transducer elements includes transducer elements of the first and second regions of transducer elements.
